(19) United States
(12) Patent Application Publication
(10) Pub. No.: US 2025/0249756 A1
(43) Pub. Date: Aug. 7, 2025

(54) CUSTOMIZATION OF DRIVING MODE OF VEHICLES

(71) Applicant: TVS MOTOR COMPANY LIMITED, Chennai (IN)

(72) Inventors: Subramoniam Chidambaram, Chennai (IN); Manu Saxena, Chennai (IN); Harne Vinay Chandrakant, Chennai (IN); Vigneshwara Raja Kesavan, Chennai (IN); Dipanjan Mazumdar, Chennai (IN)

(73) Assignee: TVS MOTOR COMPANY LIMITED, Chennai (IN)

(21) Appl. No.: 18/852,775

(22) PCT Filed: Feb. 21, 2023
(86) PCT No.: PCT/IN2023/050165

§ 371 Date: Sep. 30, 2024

(30) Foreign Application Priority Data
Mar. 30, 2022 (IN) 202241019066

(51) Int. Cl. B60L 15/20; B60L 50/60; B60L 58/10

(52) U.S. Cl. CPC B60L 15/20; B60L 50/60; B60L 58/10; B60L 2240/12; B60L 2240/14; B60L 2250/16; B60L 2260/26

(57) ABSTRACT

A Vehicle Control Unit (VCU), for an electric vehicle, is configured to: receive, from an input device, an input signal comprising a plurality of operational parameters associated with a powertrain of the electric vehicle to customize a driving mode of the electric vehicle; compare each of the operational parameters with an operable limit thereof; create, if each of the operational parameters are within the corresponding operable limit, a user profile comprising the set operational parameters; store the user profile; and regulate operation of at least one element of the powertrain based on comparison of the set operational parameters and the created user profile.

### FIELD OF INVENTION

The present subject matter is related to, in general, vehicles and, in particular, customization of driving mode of vehicles.

### BACKGROUND

A vehicle, such as an electric vehicle, includes a motor to power the vehicle and a vehicle control unit to control various functions of the vehicle. The vehicle control unit receives an input regarding the operation of the vehicle and regulates operation of one or more components of the vehicle. For instance, in response to the vehicles throttle being actuated, the vehicle control unit may trigger the control of the motor of the electric vehicle and, thereby, increase the driving speed of the vehicle.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a block diagram of an electric vehicle (EV), in accordance with an implementation of the present subject matter;

FIG. 2a illustrates a method for customizing a driving mode of an EV, in accordance with an implementation of the present subject matter;

FIG. 2b illustrates a method for customizing a driving mode of an EV, in accordance with an implementation of the present subject matter;

FIG. 3a illustrates setting of operational parameters for customizing a driving mode of an EV, in accordance with an implementation of the present subject matter;

FIG. 3b illustrates setting of operational parameters for customizing a driving mode of an EV, in accordance with an implementation of the present subject matter; and

FIG. 4 illustrates a method for customizing a driving mode of an EV, in accordance with an implementation of the present subject matter.

### DETAILED DESCRIPTION

Vehicles, such as two-wheeled electric vehicles, generally include pre-set driving modes for driving the vehicle. For instance, the vehicles may include a power mode and an economy mode. In the power mode, the vehicle may be driven with high speed and/or high acceleration, whereas the economy mode may enable driving with a higher range and greater efficiency. Upon choosing a mode, a Vehicle Control Unit (VCU) of the vehicle may retrieve previously stored operational parameters, such as a top speed, an acceleration, and the like, for the corresponding mode and may regulate operation of one or more components of the vehicle according to the retrieved operational parameters.

For instance, in the power mode, to achieve a particular value of acceleration, torque generated by a motor may have to controlled. A torque map may be calibrated to achieve a particular value of acceleration. Accordingly, upon selection of the power mode, the VCU may regulate the operation of the motor and a transmission assembly to achieve the particular value of acceleration. That is, the VCU may calibrate the torque map and the torque generated at various operating conditions, such as throttling and motor speed, may vary according to the calibration and thereby, varying the acceleration. The VCU may regulate the operation of the components through a control unit of the corresponding component. Alternatively, instead of the VCU controlling the motor through a motor control unit (MCU), the MCU may directly regulate the operation of the motor. Similarly, upon choosing the economy mode, the VCU may retrieve operational parameters corresponding to the economy mode and regulate the components of the vehicle based on the operational parameters corresponding to the economy mode.

However, in some cases, a driver, for instance, depending on preference of driving style or road or weather conditions, may not entirely be able to get accustomed to the available driving modes. In other words, the driver may prefer to have the values of operational parameters, which may not be achieved in either the power mode or in the economy mode. However, in the existing electrical vehicles, it may not be possible to re-set the operational parameters without updating the VCU by the manufacturer of the vehicle.

Further, in some scenarios, driving in both the modes may not be efficient. For instance, if the vehicle is driven down a slope, a value of regenerative power may be set to a highest value to better utilise regenerative power of the vehicle. However, in both the modes, regenerative power may not have a highest possible value. Similarly, pre-set operational parameters may not be efficient and/or safe, and may not provide an enhanced driving experience for all driving scenarios, such as varying road conditions, varying weather conditions, and the varying number of riders in the vehicle. For instance, during rainy season, the driver may prefer to have a smoothest braking pattern to avoid skidding of the vehicle. However, such an option may not be available in both pre-set modes. In an example, to alter one or more operational parameter values or to add pre-set modes, the VCU may have to be updated by the manufacturer. However, the update of the VCU is a cumbersome, complex, and a time consuming process and is, usually, rolled out as a variant and is not updated for each customer. At a workshop, the VCU may be updated, but in case the update is performed by an unskilled or untrained person, it may adversely affect the operation of the vehicle. Further, since the update is static, i.e., it cannot be modified once done, even after the update, the driver may find that, in certain scenarios, the vehicle may not be able to satisfy driving preferences or the requirements and/or may not provide efficient driving for varied driving conditions.

The present subject matter relates to a vehicle control unit (VCU) for an electric vehicle (EV) which allows for customization of operational parameters of a vehicle in order to customize a driving mode of the EV. As an example, the present subject matter allows for interface between a driver of the EV and the VCU, for instance, through an application programming interface (API), such that the driver can provide as an input various values of the operational parameters to the VCU. These input values, if valid, are then provided to various controllers of the drive train components of the EV, thereby customizing the driving mode. In said example, the VCU and the various controllers controlling the components of the drive train of the EV can be provided with or can have the flexibility of undergoing such modifications in the machine-readable instructions thereon, based on the input values provided by the driver. With the implementations of the present subject matter, different operational parameters can be set by a driver without having to update the VCU by the manufacturer. Therefore, the present subject matter accommodates and satisfies various driving preferences and provide efficient and safe driving in varied driving conditions.

In accordance with an example implementation, the VCU may receive an input signal from an input device of the EV. The EV may be, for example, a two-wheeler, a three-wheeler, a four-wheeler, or even a multi-wheeler having more than four wheels. The input signal may include a plurality of operational parameters associated with a powertrain of the EV. In an example, the operational parameters may include a top speed of the EV, an acceleration of the EV, a braking pattern of the EV, a regenerative power, and the like. In an example, the input device may allow setting of the operational parameters to customize the driving mode of the EV. The VCU may compare each of the operational parameters with an operable limit thereof. The operable limit may be a safe limit beyond which the operational parameter may cause malfunctioning of components of the EV. Further, in response to the comparison, the VCU may regulate operation of at least one element of the powertrain. For instance, if it is determined that each of the operational parameters is within the corresponding operable limit, the VCU may regulate the operation of the at least one element of the powertrain based on the set operational parameters. For example, consider that the operable limit of top speed is 100 Kilometre per hour (Kmph) and the operable limit of the acceleration is 3.5 metre (m) per second (s)². Further, consider that the top speed set is 90 Kmph and the acceleration set is 2 m/s². In such a case, upon the comparison, the VCU may determine that the set parameters are within the operable limit. In response to the determination, the VCU may trigger a motor control unit (MCU) to control a motor of the EV and a Transmission Control Unit (TCU) to control a transmission assembly of the EV to set the top speed at 90 Kmph and the acceleration at 2 m/s². In an example, upon the comparison of each of the operational parameters with the corresponding operable limit, if at least one of the operational parameters is beyond the corresponding operable limit, the VCU may send an alert to the input device to indicate that at least one of the operational parameters set is beyond the corresponding operable limit. For example, consider that the operable limit of top speed is 100 Kilometre per hour (Kmph) and the operable limit of the acceleration is 3.5 m/s². Further, consider that the top speed set is 95 Kmph and the acceleration set is 4 m/s². In such case, the VCU may determine that the set acceleration is beyond the operable limit of the acceleration and may send an alert to the input device indicating that the acceleration set is beyond the operable limit.

The present subject matter enables customization of the operational parameters for driving of the vehicle. With the present subject matter, different operational parameters can be set according to driver's preference, road conditions, weather conditions, and the like. Since the operational parameters can be customized, the present subject matter eliminates the cumbersome process of updating of the VCU by the manufacturer to alter values of the pre-set modes or to add one or more modes for the vehicle. The present subject matter makes the driving easier, safer, and enhances the efficiency of the vehicle. Further, by accommodating various driving preferences, the present subject matter enhances the driving experience.

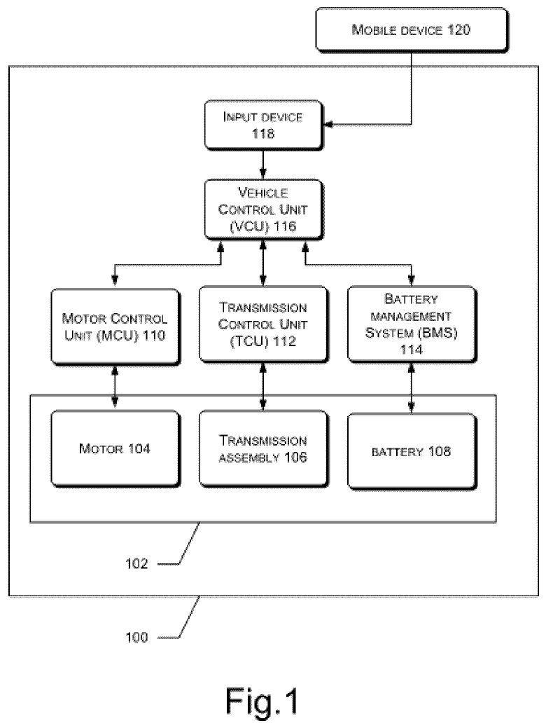

The present subject matter is further described with reference to FIGS. 1-4. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of an electric vehicle (EV) 100, in accordance with an implementation of the present subject matter. The EV 100 may be, for example, a two-wheeler. The EV 100 may include a powertrain 102 to cause movement of the EV 100. In an example, the powertrain 102 may include a motor 104, a transmission assembly 106, and a battery 108. The motor 104 may provide a driving force to drive the EV 100. The transmission assembly 106 may transmit the driving force from the motor 104 to a drive wheel (not shown in FIG. 1) of the EV 100. The battery 108 may provide electrical power to the components of the EV 100. Each component of the powertrain 102 may be controlled by an electronic control unit. In an example, the EV 100 may include a motor control unit (MCU) 110 may control the motor 104, a Transmission Control Unit (TCU) 112 may control the transmission assembly 106, and a battery management system (BMS) 114 may control the battery 108.

The EV 100 may include a vehicle control unit (VCU) 116 to control the functioning of the EV 100. For instance, the VCU 116 may be coupled to other control units, such as the MCU 110, the TCU 112, the BMS 114, and the like, of the EV 100 and regulate the operation of components of the EV 100 to control the functioning of the EV 100. The VCU 116 may enable customization of a driving mode of the EV 100. The driving mode may indicate the manner in which the EV 100 is to be driven and may include operational parameters associated with the powertrain 102 in accordance to the driving mode. The operational parameters associated with the powertrain 102 may include a top speed of the EV 100, an acceleration of the EV 100, a regenerative power, a braking pattern of the EV 100, and the like. The regenerative power is indicative of a torque of the motor 104 that is to be used for recharging the battery 108 when the EV 100 is decelerating. The braking pattern may indicate whether the braking of the EV 100 is to be a smooth braking or a harsh braking. The smooth braking indicates that the EV 100 is to slowly decelerate on applying a brake (not shown in FIG. 1) of the EV 100. The harsh braking indicates that the EV 100 is to be suddenly decelerated while applying the brake. The operational parameters associated with the powertrain 102 may be hereinafter referred to as “operational parameters”.

In an example, the driving mode may include pre-set modes and a custom mode. The pre-set modes indicate that modes were already pre-set in the VCU 116 during manufacturing of the EV 100. The pre-set modes may include a power mode and an economy mode. The power mode may include the operational parameters that may enable the EV 100 to drive with high speed and high acceleration. The economy mode may include the operational parameters that may enable the EV 100 to achieve high range and thereby, enabling better mileage of the EV 100.

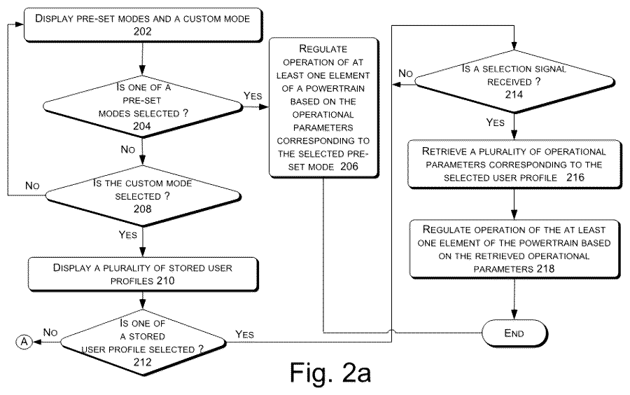

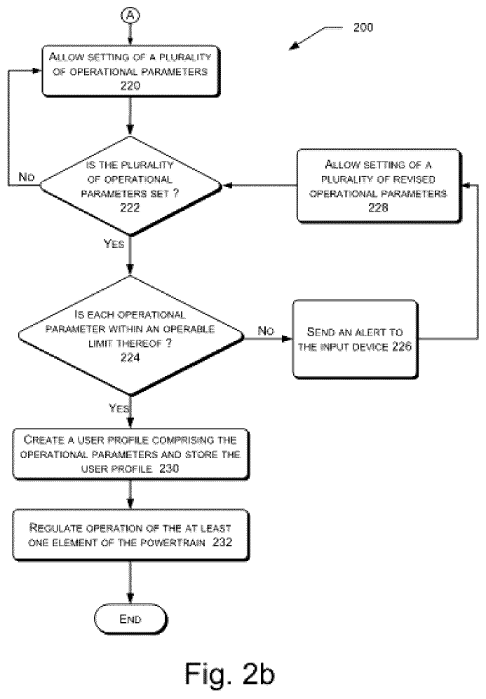

In the custom mode, the EV 100 may enable a rider to set the operational parameters so that the EV 100 can be driven according to driver's preference. Further, in an example, the custom mode may also include a plurality of stored user profiles to enable selection of a user profile from among the plurality of stored user profiles. Each stored user profile may be, for example, a user profile created by using a plurality of operational parameters set at an earlier instance by a driver to customize the driving mode. Upon selection, a stored user profile may be retrieved to drive the EV 100 according to a driver's preference, as will be described in detail with reference to FIG. 2a and FIG. 2b. In the present subject matter, by choosing the custom mode, the driving mode of the EV 100 can be customized. Therefore, the present subject matter eliminates the updating of the VCU 116 by the manufacturer of the EV 100 to alter values of the pre-set modes or to add one or more pre-set modes for the EV 100.

Further, since the present subject matter allows storage of the user profile corresponding to the set operational parameters, each time a driver may not have to set the operational parameters. Instead, the EV 100 may allow selection of a stored user profile and retrieval of the operational parameters corresponding to the stored user profile. Therefore, the present subject matter eases the operability of the EV 100, especially in scenarios where each time the driver may want to drive the EV 100 with the same set of operational parameters.

Further, in some scenarios, the EV 100 may be driven by multiple people in a single trip, where each driver may have their own driving preference. In such scenarios, the present subject matter enables each driver to customize the driving mode according to their preferences by either retrieving from the stored user profile or by setting a new set of operational parameters. The operation of the EV 100 may be described in detail with reference to FIGS. 2a-2b.

In an example, the EV 100 may include an input device 118. The input device 118 may be communicatively coupled to the VCU 116 to send signals to the VCU 116. In an example, the input device 118 may be a thin-film-transistor (TFT) cluster, a liquid crystal display (LCD) screen, or a light-emitting diode (LED) display. The input device 118 may display various parameters, such as different driving modes of the EV 100, a current driving mode of the EV 100, a driving speed of the EV 100, a braking pattern of the EV 100, a fuel level, an oil level, and the like. In an example, the input device 118 may allow setting of operational parameters to customize the driving mode of the EV 100. Accordingly, to allow the setting of the operational parameters, the input device 118 may include a touch sensor (not shown in FIG. 1). Additionally, the input device 118 may also enable selection of the driving mode of the EV 100 and the selection of a stored user profile of the EV 100.

In an example, instead of the input device 118 allowing to set the operational parameters, the driving mode, or a stored user profile, the EV 100 may be connected with a mobile device 120 which can be connected to the vehicle with wired or wireless connections. For instance, the mobile device 120 may allow logging in to select a user profile from the plurality of user profiles using a user identification, as will be described in detail with reference to FIGS. 2a and 2b. Therefore, through the mobile device 120, different drivers of the EV, for instance, different members of a family, can set their preference of the operational parameters for when they want to ride the EV in customize mode and not use the default modes. Accordingly, for the same vehicle, different drivers can login whom the VCU 116 can identify based on the login credentials and, therefore, can configure the predefined modes on the EV 100 as per that particular driver's preference.

In an example, the mobile device 120 may be, for example, a cell phone, a smart card, a personal digital assistant (PDA) held by the driver, a smart accessory worn by a driver, such as a smart watch, a remote server, a laptop, or the like. In an example, the mobile device 120 may be connected to the EV 100 using Bluetooth, Wireless fidelity (Wi-fi), a cellular communication, infrared, or a wired connection.

In an example, the EV 100 may include a vehicle bus (not shown in FIG. 1) for enabling communication among various components of the EV 100, such as the VCU 116, the input device 118, the MCU, 110, the TCU 112, and the BMS 114. The vehicle bus may be, for example, Control Area Network (CAN) bus. The operation of the EV 100 for customization of the driving mode is as follows:

In an example, the input device 118 may display the different driving modes of the EV 100, such as the pre-set modes and the custom mode. The input device 118 may further allow selection of a mode from the displayed modes. In an example, to customize the driving mode of the EV, the custom mode may be selected on the input device 118. The selection of the custom mode may enable the setting of operational parameters. In one example, the operational parameters may be provided or displayed to the driver on the input device 118 and, in such a case, the extent of modification of the operational parameter may be the limited based on the options provided on the input device 118. Accordingly, the VCU 116 may allow such operational parameters to be selected by the driver without having to check whether the operational parameters are within the range or allowable or not. In other examples, as discussed previously and also henceforth, the limits of the operational parameters may not be provided or the driver may not be aware of the limits, and in such cases, the VCU 116 can determine the feasibility or allowability of the operational parameters as input by the driver.

In response to the setting of the operational parameters, the input device 118 may send an input signal comprising the set operational parameters to the VCU 116. The VCU 116 may receive the input signal from the input device 118. The VCU 116 may compare each of the operational parameters with an operable limit thereof. The operable limit may be a safe limit beyond which the operational parameter may cause malfunctioning of components of the EV 100. For instance, the operable limit of the top speed may be 95 Kmph, which indicates that having a top speed beyond 95 Kmph may cause malfunctioning of the EV 100. Further, in response to the comparison, the VCU 116 may regulate operation of at least one element of the powertrain 102. For instance, if it is determined that each of the operational parameters is within the corresponding operable limit, the VCU 116 may regulate the operation of the at least one element of the powertrain 102 based on the set operational parameters. For example, consider that the operable limit of top speed is 100 Kmph and the operable limit of the acceleration is 3.5 m/s². Further, consider that the top speed set is 90 Kmph and the acceleration set is 2 m/s². The VCU 116 may, upon the comparison, determine that the set parameters are within the operable limit. In response to the determination, the VCU 116 may trigger the MCU 110 to control the motor 104 and the TCU 112 to control the transmission assembly 112 to set the top speed at 90 Kmph and the acceleration at 2 m/s². In another example, upon the comparison of each of the operational parameters with the corresponding operable limit, if at least one of the operational parameters is beyond the corresponding operable limit, the VCU 116 may send an alert to the input device 118 to indicate that at least one of the operational parameters set is beyond the corresponding operable limit. For example, consider that the operable limit of top speed is 100 Kmph and the operable limit of the acceleration is 3.5 m/s². Further, consider that the top speed set is 95 Kmph and the acceleration set is 4 m/s². In such case, the VCU 116 may determine that the set acceleration is beyond the operable limit of the acceleration and may send an alert to the input device 118 indicating that the acceleration is beyond the operable limit.

FIG. 2a illustrates a method 200 for customizing a driving mode of an EV, in accordance with an implementation of the present subject matter. The order in which the method 200 is described is not intended to be construed as a limitation, and any number of the described method blocks may be combined in any order to implement the method 200 or an alternative method. Furthermore, the method 200 may be implemented by processor(s) or computing device(s) through any suitable hardware, non-transitory machine-readable instructions, or a combination thereof. The EV may correspond to the EV 100 and the method 200 may be performed by the EV 100.

At block 202, an input device may display a plurality of pre-set modes and a custom mode to allow selection of one of the pre-set modes or the custom mode. The input device may, for example, correspond to the input device 118. The pre-set modes may include a power mode and an economy mode. To display the modes, the EV may include a mode switch, which may be provided on a handle bar of the EV. In an example, upon switching on the EV, pressing the brake switch while applying a brake of the EV may cause the input device to display the pre-set modes and the custom mode.

At block 204, the input device may sense if one of the pre-set modes is selected. If it is sensed that one of the pre-set modes is selected, at block 206, a VCU may regulate operation of the at least one element of a powertrain based on the operational parameters corresponding to the selected pre-set mode. For instance, if the power mode is selected, at block 206, the VCU may regulate operation of the at least one element of the powertrain based on the operational parameters corresponding to the power mode. Similarly, if the economy mode is selected, at block 206, the VCU may regulate operation of the at least one element of the power train based on the operational parameters corresponding to the economy mode. The powertrain may correspond to the powertrain 102 and the VCU may correspond to the VCU 116.

As mentioned earlier, in some scenarios, a driver may prefer to customize a driving mode of the EV to ride the EV according to his preference, road conditions, weather conditions, or the like. In such scenarios, the driver may select the custom mode in the input device instead of selecting one of the pre-set modes. Therefore, if it is sensed that the neither of the pre-set modes are selected, at block 208, the input device may sense if the custom mode is selected. If it is sensed that the custom mode is selected, at block 210, the input device may display a plurality of stored user profiles to allow selection of a user profile from the plurality of stored user profile. Each stored user profile may include a plurality of operational parameters. Each stored user profile may be, for example, a user profile created by using a plurality of operational parameters set at an earlier instance by a driver to customize the driving mode of the EV. The storing of a user profile will be explained with reference to FIG. 2b. If it is sensed that the custom mode is not selected, the input may display the pre-set modes and the custom mode, at block 202.

Further, at block 212, the input device may sense if a user profile from the plurality of the stored user profiles is selected. In an example, if a user profile is selected, the input device may send a selection signal corresponding to the selected user profile to the VCU. If it is sensed that one of the user profiles is not selected, the method may proceed to perform further steps, as will be discussed with reference to FIG. 2b, through “A”. Further, at block 214, the VCU may determine if a selection signal is received. If the VCU determines that the selection signal is not received, at block 212, the VCU may determine if one of the stored user profiles is selected.

On the other hand, if the selection signal is received, at block 216, the VCU may retrieve a plurality of operational parameters corresponding to the selected user profile. Subsequently, at block 218, the VCU may regulate operation of the at least one element of the power train based on the retrieved operational parameters.

In the above example, the input device allows to select a user profile from the plurality of stored user profiles. In an example, instead of the input device allowing to select a user profile from the plurality of stored user profile, a mobile device may be used to select the user profile. The mobile device may, for example, correspond to the mobile device 120. For instance, the mobile device may be connected to the EV. The mobile device may allow logging in to select a user profile from the plurality of user profiles using a user identification. For instance, the user profile along with the operational parameters corresponding to the user profile may be stored along with a user identification in a memory of the VCU. The mobile device may include a software application which may allow logging in using the user identification. Further, in response to logging in, the mobile device may send an input request to the input device corresponding to the user identification. The VCU may receive an input request from the input device and retrieve the plurality of operational parameters corresponding to the selected user profile based on the input request. In other words, the VCU may retrieve the user profile and the plurality of operational parameters corresponding to the user identification. Further, upon the retrieval, the VCU may regulate the operation of the at least one element of the powertrain based on the retrieved operational parameters. Since, in the present subject matter, a user profile can be selected, and the operational parameters can be retrieved by logging in from a mobile device, the present subject matter eases the process of customization of driving mode. Further, in scenarios, where different people are to drive the EV, such as in cases where the EV is to be used by different members of a family, the present subject matter eases the operability of the EV and enhances the driving experience of the EV by making each driver ride according to their preference just by selecting a user profile.

FIG. 2b illustrates the method 200 for customizing a driving mode of the EV, in accordance with an implementation of the present subject matter. At block 212 in FIG. 2a, if a user profile from the plurality of user profiles is not selected, the method 200 may proceed to perform block 220. At block 220, the input device may allow setting of a plurality of operational parameters. In an example, the input device may allow to a driver to key-in the values of the operational parameters. For instance, the input device may provide a key pad for keying in the values.

Further, at block 222, the input device may sense if the plurality of operational parameters is set. If it is sensed that the plurality of operational parameters is set, at block 224, the VCU may compare each operational parameter with the operable limit thereof. The plurality of operational parameters may include a top speed of the EV, an acceleration of the EV, a regenerative power of the EV, and a braking pattern of the EV.

If it is determined that at least one of the operational parameters is beyond the operable limit, at block 226, the VCU may send an alert to the input device. The alert may indicate that at least one of the operational parameters is beyond the corresponding operable limit. Subsequently, the input device may display the alert to the driver that the operational parameter is beyond the corresponding operable limit. For example, consider that the operable limit of top speed is 100 Kmph, the operable limit of the acceleration is 3.5 m/s², and the operable limit of the regenerative power is −50 Nm. Further, consider that the top speed set is 95 Kmph, the acceleration set is 4 m/s², and the regenerative power set is −45 Nm. In such case, the VCU may determine that the set acceleration is beyond the operable limit of the acceleration and may send the alert to the input device indicating that the acceleration is beyond the operable limit. In an example, upon sending the alert may also prompt the driver to allow setting of a plurality of revised operational parameters, at block 228. Subsequently, the method 200 may proceed to perform the step at block 222 from the step at block 228. In other words, subsequent to allowing setting of the plurality of revised operational parameters, at block 222, the input device may sense if the plurality of the revised operational parameters is set and all the revised operational parameters are within the corresponding limit, at block 224.

If the VCU determines that each operational parameter is with the corresponding operable limit, at block 230, the VCU may create a user profile comprising the set operational parameters and store the user profile. For example, consider that the operable limit of top speed is 100 Kmph, the operable limit of the acceleration is 3.5 m/s², and the operable limit of the regenerative power of the EV may be −50 Nm. Further, consider that the top speed set is 90 Kmph, the acceleration set is 2 m/s², and the regenerative power set is −40 Nm. In such case, the VCU may determine that the set parameters are within the corresponding operable limit and may create and store the user profile with the top speed as 90 Kmph, the acceleration as 2 m/s², and the regenerative power as −40 Nm.

In an example, the user profile and the corresponding operational parameters may be stored in a memory of the VCU. As will be understood, each time a plurality of operational parameters is set and are determined to be within the corresponding operable limit, the user profile with the set operational parameters may be created and stored, thereby forming the plurality of stored user profiles.

Further, at block 232, the VCU may regulate the operation of the at least one element of the powertrain based on the set operational parameters. In an example, the regulation may include triggering a MCU to control the motor, a TCU to control the transmission assembly, and a BMS to control the battery. For instance, the VCU may trigger the MCU, the TCU, and the BMS to set the top speed to 90 Kmph, the acceleration to 2 m/s², and the regenerative power to −40 Nm. The MCU may correspond to the MCU 110, the TCU may correspond to the TCU 112, and the BMS may correspond to the BMS 114.

In the above examples, the operational parameters are explained being keyed-in as values. However, in some examples, instead of keying-in the values of the operational parameters, a visual indicator, such as a graphical equalizer, may be provided for setting of the operational parameters.

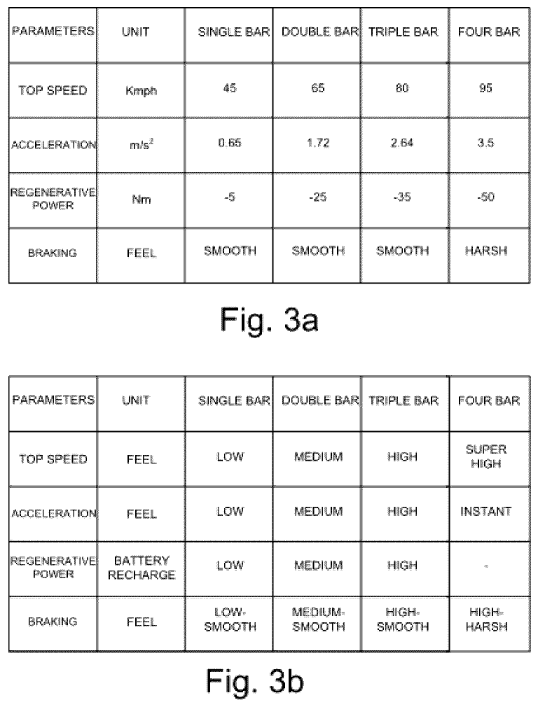

FIG. 3a illustrates setting of operational parameters for customizing a driving mode of the EV 100, in accordance with an implementation of the present subject matter. FIG. 3b illustrates setting of operational parameters for customizing a driving mode of the EV 100, in accordance with an implementation of the present subject matter. For the sake of brevity, FIGS. 3a and 3b are explained in conjunction with each other. In an example, a visual indicator may be provided for setting of the operational parameters. Each visual indicator may correspond to an operational parameter. The visual indicator may be, for example, graphic-equalizer like and may include at least one bar. The number of bars in the visual indicator may indicate the value of the operational parameter. In other words, higher the number of bars, higher is the value of the operational parameter and lower the number of bars, lower is the value of operational parameter. In some instances, the number of bars may indicate the feel to be obtained corresponding to the operational parameters. For instance, having higher number of bars for the braking pattern may indicate harsh braking and having lower number of bars may indicate smooth braking.

In an example, as is depicted in FIG. 3a, adjusting the number of bars may correspond to setting the operational parameter to a specific value. For instance, when the visual indicator corresponding to the top speed is set to have a single bar, the top speed may be set as 45 Kmph. Similarly, if the visual indicator corresponding to the top speed is set to have four bars, the top speed may be set at 95 Kmph.

In another example, as is depicted in FIG. 3b, adjusting the number of bars may indicate adjusting the feel to be obtained corresponding to the operational parameter. For instance, if the visual indicator corresponding to the acceleration has four bars, the acceleration value set may be highest that is allowable in the EV, whereas if the visual indicator corresponding to the acceleration has a single bar, acceleration value set may be least, as is depicted in FIG. 3B.

In the above examples, the VCU 116 is explained to control the motor 104 by triggering the MCU 110, to control the transmission assembly 106 by triggering the TCU 112, and to control the battery 108 by triggering the BMS 114. However, in an example, the MCU 110 may directly regulate the operation of the motor 104 and the VCU may control only the transmission assembly 106 by triggering the TCU 112 and the battery 108 by triggering the BMS 114. In this regard, the MCU 110 may be coupled to the input device 118.

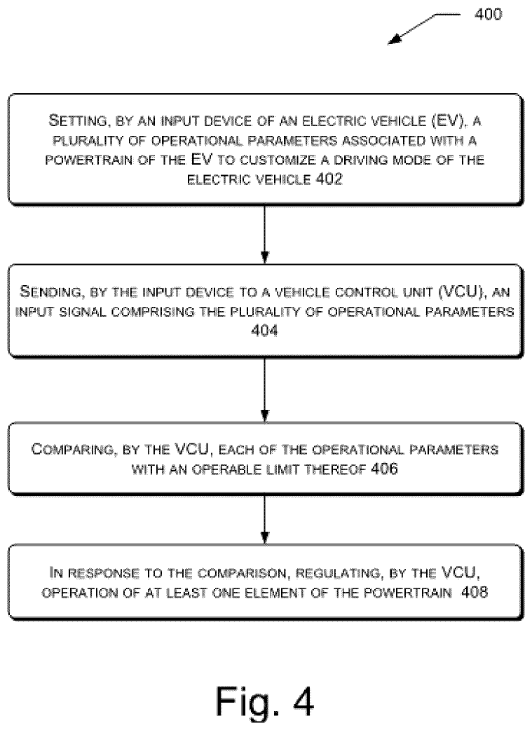

FIG. 4 illustrates a method 400 for customizing a driving mode of an EV, in accordance with an implementation of the present subject matter. The order in which the method 400 is described is not intended to be construed as a limitation, and any number of the described method blocks may be combined in any order to implement the method 400 or an alternative method. Furthermore, the method 400 may be implemented by processor(s) or computing device(s) through any suitable hardware, non-transitory machine-readable instructions, or a combination thereof. The EV may correspond to the EV 100.

At block 402, a plurality of operational parameters associated with a powertrain of the EV may be set by an input device of the EV to customize a driving mode of the EV. The powertrain may correspond to the powertrain 102 may include the motor 104, the battery 108, and the transmission assembly 106. The input device may correspond to the input device 118. In an example, the operational parameters may include a top speed of the EV, an acceleration of the EV, a regenerative power of the EV, and a braking pattern of the EV.

At block 404, an input signal may be sent by the input device to a VCU. The input signal may include the plurality of operational parameters. The VCU may correspond to the VCU 116. At block 406, each of the operational parameters may be compared with an operable limit thereof, by the VCU.

At block 408, in response to the comparison, operation of at least one element of the powertrain may be regulated by the VCU. In an example, to regulate the operation of the at least one element of the powertrain, an MCU, a TCU, a BMS, or a combination thereof may be triggered. The MCU may control the motor, the TCU may control the transmission assembly, and the BMS may control the battery. The VCU may trigger the MCU to modify an MCU mapping, the TCU to modify a TCU mapping, and the BMS to modify a BMS mapping. The MCU may correspond to the MCU 110, the TCU may correspond to the TCU 112, and the BMS may correspond to the BMS 114.

In an example, upon the comparison of each of the input parameters with the corresponding operable limit, the method 400 may further include sending an alert to the input device if at least one of the operational parameters is beyond the corresponding operable limit. The alert may be sent by the VCU and may indicate that at least one of the operational parameters set is beyond the corresponding operable limit.

The present subject matter enables customization of the operational parameters for driving of the EV. With the present subject matter, different operational parameters can be set according to driver's preference, road conditions, weather conditions, and the like. Since the operational parameters can be customized, the present subject matter eliminates the cumbersome process of updating of the VCU by the manufacturer to alter values of the pre-set modes or to add one or more modes for the EV. The present subject matter makes the driving easier, safer, and enhances the efficiency of the EV. Further, since the present subject matter allows storage of a user profile corresponding to the set operational parameters, each time a driver may not have to set the operational parameters. Instead, the EV may allow selection of a stored user profile and retrieval of the operational parameters corresponding to the stored user profile. Therefore, the present subject matter eases the process of customization of the driving mode, especially in scenarios where each time a driver may want to drive the EV with the same set of operational parameters. Further, in the present subject matter, a user profile can be selected, and the operational parameters can be retrieved by logging in from a mobile device. Therefore, the present subject matter eases the process of customization of driving mode. Further, in scenarios, where different people, such as different members of a family, are to drive the EV the present subject matter eases the operability of the EV and enhances the driving experience of the EV by making each driver ride according to their preference just by selecting a user profile from either the Input device or from the mobile device.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

1. A Vehicle Control Unit (VCU), for an electric vehicle, is configured to:
receive, from an input device, an input signal comprising a plurality of operational parameters associated with a powertrain of the electric vehicle to customize a driving mode of the electric vehicle;
compare each of the operational parameters with an operable limit thereof;
create, if each of the operational parameters are within the corresponding operable limit, a user profile comprising the plurality of operational parameters;
store the user profile; and
regulate operation of at least one element of the powertrain based on comparison of the set operational parameters and the created user profile.

2. The VCU as claimed in claim 1, wherein
upon the comparison of each of the operational parameters with the corresponding operable limit, if at least one of the operational parameters is beyond the corresponding operable limit, the VCU is configured to send an alert to the input device to indicate that at least one of the operational parameters set is beyond the corresponding operable limit.

3. The VCU as claimed in claim 1, wherein
upon sending of an alert to the input device, the VCU is configured to:
receive, from the input device, a revised input signal, wherein the revised input signal comprises a plurality of revised operational parameters associated with the powertrain of the electric vehicle to customize a driving mode of the electric vehicle;
compare each of the revised operational parameters with the corresponding operable limit; and
regulate, in response to the comparison, operation of at least one element of the powertrain based on the revised operational parameters.

4. The VCU as claimed in claim 1, wherein
at least one element of the powertrain comprises:
a motor that provides driving force to drive the electric vehicle;
a transmission assembly that transmits driving force from the motor to a drive wheel of the electric vehicle; and
a battery that provides electrical power to components of the electric vehicle.

5. The VCU as claimed in claim 1, wherein
for the regulation of operation of the at least one element of the powertrain, the VCU is configured to trigger at least one of:
a Motor Control unit (MCU) to modify an MCU mapping, wherein the MCU is configured to control a motor of the electric vehicle;
a Transmission Control Unit (TCU) to modify a TCU mapping, wherein the TCU is configured to control a transmission assembly of the electric vehicle; and
a Battery Management System (BMS) to modify a BMS mapping, wherein the BMS is configured to control a battery of the electric vehicle.

6. The VCU as claimed in claim 1, wherein
the plurality of operational parameters comprises: a top speed of the electric vehicle, an acceleration of the electric vehicle, a regenerative power of the electric vehicle, and a braking pattern of the electric vehicle.

7. An electric vehicle comprising:
an input device configured to:
allow setting of a plurality of operational parameters associated with a powertrain of the electric vehicle to customize a driving mode of the electric vehicle; and
send, upon the allowing of setting of the plurality of operational parameters, an input signal comprising the plurality of operational parameters to a vehicle control unit (VCU);
the powertrain is configured to drive the electric vehicle; and
the VCU is configured to:
receive the input signal;
compare each of the operational parameters with an operable limit thereof; and
regulate, in response to the comparison, operation of at least one element of the powertrain;
create, if each of the operational parameters are within the corresponding operable limit, a user profile comprising the plurality of operational parameters;
store the user profile; and
regulate operation of at least one element of the powertrain based on comparison of the set operational parameters and the created user profile.

8. The electric vehicle as claimed in claim 7, wherein
upon the comparison of each of the input parameters with the corresponding operable limit:
in response to at least one of the operational parameters is beyond the corresponding operable limit, the VCU is configured to:
send an alert to the input device to indicate that at least one of the operational parameters set is beyond the corresponding operable limit, and
the input device is configured to display the alert received from the VCU.

9. The electric vehicle as claimed in claim 7, wherein
upon display of an alert,
the input device is configured to:
allow setting of a plurality of revised operational parameters associated with the powertrain of the electric vehicle to customize a driving mode of the electric vehicle; and
send, to the VCU, a revised input signal comprising the plurality of revised operational parameters; and
the VCU is configured to:
receive, from the input device, the revised input signal;
compare each of the revised operational parameters with the corresponding operable limit; and
regulate, in response to the comparison, operation of at least one element of the powertrain based on the revised operational parameters.

10. (canceled)

11. The electric vehicle as claimed in claim 7, wherein
prior to allowing the setting of the plurality of operational parameters, the input device is configured to perform one of:
allowing selection of a user profile from a plurality of stored user profiles,
wherein each user profile comprises a preset combination of values of the plurality of operational parameters associated with the powertrain of the electric vehicle,
wherein the VCU is configured to store a user profile if each of the plurality of operational parameters received from the input device in the preset combination is within the operable limit thereof,
wherein the input device is configured to allow a user to login to select the user profile from the plurality of user profiles using a user identification; and
allowing the setting of the plurality of operational parameters.

12. The electric vehicle as claimed in claim 11, wherein
upon allowing the selection of a user profile,
the input device is configured to send a selection signal corresponding to the selection of the user profile; and
the VCU is configured to:
receive the selection signal from the input device;
retrieve a plurality of operational parameters corresponding to the selected user profile upon receipt of the selection signal; and
regulate operation of at least one element of the powertrain based on the retrieved operational parameters.

13. The electric vehicle as claimed in claim 11, wherein
a mobile device is connected to the electric vehicle is configured to:
allow logging in to select a user profile from the plurality of user profiles using a user identification; and
send an input request to the input device corresponding to the user profile; and
the VCU is configured to:
receive the input request from the input device;
retrieve the plurality of operational parameters corresponding to the selected user profile based on the input request; and
regulate operation of at least one element of the powertrain based on the retrieved operational parameters.

14. The electric vehicle as claimed in claim 13, wherein
the mobile device is connected to the electric vehicle using one of: Bluetooth, Wireless fidelity (Wi-fi), cellular communication, infrared, and a wired connection.

15. The electric vehicle as claimed in claim 11, comprising:
a brake;
a handle bar; and
a switch mounted on the handle bar, wherein
application of the brake while pressing the switch causes the input device to display the plurality of stored user profiles to allow the selection of a user profile from the plurality of stored user profiles.

16. The electric vehicle as claimed in claim 7, wherein
the input device is a thin-film-transistor cluster liquid crystal display, and wherein the input device comprises a touch sensor.

17. The electric vehicle as claimed in claim 7, wherein
the at least one element of the powertrain comprises:
a motor to provide driving force to drive the electric vehicle;
a transmission assembly to transmit driving force from the motor to a drive wheel of the electric vehicle; and
a battery to provide electrical power to components of the electric vehicle.

18. The electric vehicle as claimed in claim 7, comprising:
a motor control unit (MCU) to control a motor of the electric vehicle;
a transmission control unit (TCU) to control a transmission assembly of the electric vehicle; and
a battery management system (BMS) to control a battery of the electric vehicle, wherein
for the regulation of operation of the at least one element of the powertrain, the VCU is configured to trigger at least one of:
the MCU to modify an MCU mapping;
the TCU to modify a TCU mapping; and
the BMS to modify a BMS mapping.

19. The electric vehicle as claimed in claim 7, wherein
the plurality of operational parameters comprises: a top speed of the electric vehicle, an acceleration of the electric vehicle, a regenerative power of the electric vehicle, and a braking pattern of the electric vehicle.

20. A method for customizing a driving mode of an electric vehicle, the method comprising:
setting, by an input device of the electric vehicle, a plurality of operational parameters associated with a powertrain of the electric vehicle to customize a driving mode of the electric vehicle;
sending, by the input device of the electric vehicle to a vehicle control unit (VCU) of the electric vehicle, an input signal comprising the plurality of operational parameters;
comparing, by the VCU, each of the operational parameters with an operable limit thereof.

21. The method as claimed in claim 20, wherein
upon the comparison of each of the input parameters with the corresponding operable limit, the method comprises:
sending, if at least one of the operational parameters is beyond the corresponding operable limit, by the VCU to the input device, an alert to indicate that at least one of the operational parameters set is beyond the corresponding operable limit.
